(19) United States
(12) Patent Application Publication
(10) Pub. No.: US 2026/0029303 A1
(43) Pub. Date: Jan. 29, 2026

(54) OPTICAL FREQUENCY COMB GENERATOR FOR DISTRIBUTED ACOUSTIC ANOMALY DETECTION

(71) Applicant: Pure Technologies U.S. Inc., Columbia, MD (US)

(72) Inventors: John Allison McIntyre, Calgary (CA); Marshall Glen Kennedy, Calgary (CA)

(21) Appl. No.: 18/787,495

(22) Filed: Jul. 29, 2024

(51) Int. Cl. G01M 11/08

(52) U.S. Cl. CPC G01M 11/085

(57) ABSTRACT

Disclosed herein is an optical frequency comb generator for a distributed acoustic anomaly detection system. The system can include a continuous wave frequency modulated laser source configured to generate a laser signal. The system can include an acousto-optical modulator configured to modulate the laser signal by altering an amplitude and/or frequency of the laser signal based on an RF drive signal applied to the AOM, and to output an optical pulse with multiple frequency sidebands based on the modulation. The output can form an optical frequency comb usable detecting and locating acoustic anomalies within a structure under observation.

### FIELD

The present inventive concepts relate generally to optical sensing and monitoring systems and, more specifically, to optical frequency comb generators used in distributed acoustic anomaly detection systems.

### BACKGROUND

Distributed fiber-optic acoustic sensors, including systems based on Phase-Optical Time Domain Reflectometry (OTDR) and other interferometric techniques, can be used for monitoring the integrity of civil structures such as pipelines, bridges, and other infrastructures. These sensors can detect various events of interest, such as leaks, construction-related strikes, or other acoustic or vibrational disturbances that may indicate structural issues.

Phase-OTDR systems and similar interferometric sensors typically rely on the analysis of weak backscattered signals, often constituting a very small percentage of the initial light pulse launched into the optical fiber. Enhancing the optical pulse width can increase the amount of light launched into the fiber, but this can compromise the accuracy of event localization. Additionally, increasing the power of the light pulses up to the threshold of non-linear effects can further complicate the system's performance and reliability.

Improving the system's signal-to-noise ratio and reducing susceptibility to interference fading are ongoing challenges. The interaction of different optical frequencies with the Rayleigh backscatter at specific locations may yield stronger and more distinguishable signals, enhancing the detection and localization capabilities of the monitoring system. Reducing the complexity and cost of existing systems while maintaining high sensitivity and precision in monitoring structural health is a continual focus in the field.

### SUMMARY

Certain illustrative examples are described in the following numbered clauses:

Clause 1. An optical frequency comb generator for a distributed acoustic anomaly detection system, comprising:
a continuous wave (CW) frequency modulation (FM) laser source configured to generate a laser signal; and
an acousto-optic modulator (AOM) configured to modulate the laser signal by altering an amplitude and frequency of the laser signal based on an RF drive signal applied to the AOM, and to output an optical pulse with multiple frequency sidebands based on the modulation,
wherein the output forms an optical frequency comb usable for detecting and locating acoustic anomalies within a structure under observation.

Clause 2. The optical frequency comb generator of clause 1, wherein the laser signal undergoes sine wave modulation, and wherein the optical frequency comb comprises symmetrically spaced sidebands.

Clause 3. The optical frequency comb generator of any of the preceding clauses, wherein the laser signal undergoes sine wave modulation, such that the laser signal is characterized by a fundamental frequency, and wherein the AOM modulates the laser signal such that the outputted optical pulse comprises sidebands for the fundamental frequency.

Clause 4. The optical frequency comb generator of any of the preceding clauses, wherein the laser signal undergoes harmonic-rich, non-sinusoidal modulation such that the laser signal is characterized by a fundamental frequency and a series of odd harmonic frequencies, and wherein the AOM modulates the laser signal such that the outputted optical pulse comprises sidebands for the fundamental frequency and at least one of the odd harmonic frequencies.

Clause 5. The optical frequency comb generator of clause 4, wherein the outputted optical pulse comprises at least the 1st, 3rd, and 5th harmonic frequencies.

Clause 6. The optical frequency comb generator of clause 4, wherein the sidebands are spaced apart with a guard band between adjacent sidebands, a guard width being greater than an inverse of a pulse width generated by the optical comb generator output.

Clause 7. The optical frequency comb generator of clause 6, wherein the harmonic-rich, non-sinusoidal modulation is at least one of square, sawtooth, or triangle wave modulation.

Clause 8. The optical frequency comb generator of any of the preceding clauses, wherein the multiple frequency sidebands interact variably with Rayleigh backscatter within an optical fiber, thereby providing differentiated signal strengths at distinct frequencies to improve a probability of the detecting and locating.

Clause 9. The optical frequency comb generator of any of the preceding clauses, wherein the laser source is configured to operate with a square wave modulation, and wherein the square wave modulation increases a density of the optical frequency comb as compared to a laser source operating with a sine wave modulation.

Clause 10. The optical frequency comb generator of any of the preceding clauses, further comprising an optical isolator positioned between the CW FM laser source and the AOM, wherein the optical isolator inhibits feedback into the laser source and stabilizes the laser signal.

Clause 11. The optical frequency comb generator of any of the preceding clauses, wherein an optical fiber transmits the optical frequency comb and returns a signal indicative of acoustic anomalies within the structure.

Clause 12. The optical frequency comb generator of clause 11, wherein a data acquisition system demodulates the signal indicative of acoustic anomalies into a baseband frequency for subsequent analysis, wherein the data acquisition system converts the optical signal to an electrical signal, resulting in a complex waveform. The raw waveform is processed in software, where it is passed through parallel or sequential band-pass filters to generate the signal of interest.

Clause 13. The optical frequency comb generator of clause 12, wherein a data acquisition system receives the demodulated signal from the coherent receiver and determines a location of the acoustic anomalies within the structure based on said signal.

Clause 14. The optical frequency comb generator of any of the preceding clauses, wherein the optical frequency comb generator is part of a monitoring system for at least one of pipelines, bridges, or civil structures.

Clause 15. The optical frequency comb generator of any of the preceding clauses, wherein the optical frequency sidebands are generated based on an FM modulation frequency from the CW FM laser and an RF frequency of the RF drive signal of the AOM, resulting in a series of sidebands spread about the AOM carrier frequency. In the case of pure sinusoidal FM, the sidebands may be equally spaced on both sides of the center AOM carrier frequency.

Clause 16. The optical frequency comb generator of any of the preceding clauses, further comprising a band-pass filter configured to limit a spread of the optical frequency comb pulse to a predetermined number of sidebands.

Clause 17. A distributed acoustic anomaly detection system comprising:
optical frequency comb generator configured to output an optical frequency comb pulse with multiple frequency sidebands, wherein the optical frequency comb generator comprises a source of a continuous wave frequency modulation (FM) light configured to provide a light signal, and an acousto-optic modulator (AOM) for modulating the light signal to generate the optical frequency comb pulse;
an optical fiber configured to transmit the optical frequency comb pulse and to return a signal indicative of acoustic anomalies within a structure under observation;
a coherent receiver configured to demodulate the returned signal into a baseband frequency; and
a data acquisition system configured to determine location information for the acoustic anomalies.

Clause 18. The distributed acoustic anomaly detection system of clause 17, wherein the light signal has sine wave modulation, and wherein the optical frequency comb comprises symmetrically spaced sidebands.

Clause 19. The distributed acoustic anomaly detection system of any of clauses 17 to 18, wherein the light signal undergoes square wave modulation such that the light signal is characterized by a fundamental frequency and a series of odd harmonic frequencies, and wherein the AOM modulates the light signal such that the outputted optical pulse comprises sidebands for the fundamental frequency and at least one of the odd harmonic frequencies.

Clause 20. The distributed acoustic anomaly detection system of any of clauses 17 to 19, wherein the light signal undergoes sine wave modulation, such that the light signal is characterized by a fundamental frequency, wherein the AOM modulates the light signal such that the outputted optical pulse comprises sidebands for the fundamental frequency, and wherein the fundamental frequency is at least one of a laser light frequency, an AOM carrier frequency, or a CW FM modulation frequency.

Clause 21. The distributed acoustic anomaly detection system of any of clauses 17 to 20, wherein the multiple frequency sidebands interact variably with Rayleigh backscatter within an optical fiber, thereby providing differentiated signal strengths at distinct frequencies to improve the sensitivity of the detecting and locating.

Clause 22. The distributed acoustic anomaly detection system of any of clauses 17 to 21, wherein the light source is configured to operate with a square wave modulation, and wherein the square wave modulation increases a density of the optical frequency comb as compared to the light source operating with a sine wave modulation.

Clause 23. The distributed acoustic anomaly detection system of any of clauses 17 to 22, further comprising an optical isolator positioned between the CW FM light source and the AOM, wherein the optical isolator inhibits feedback into the light source and stabilizes the light signal.

### BRIEF DESCRIPTION OF THE DRAWINGS

Throughout the drawings, reference numbers can be re-used to indicate correspondence between referenced elements. The drawings are provided to illustrate embodiments of the present disclosure and do not to limit the scope thereof.

FIG. 1 is a schematic diagram illustrating an embodiment of a distributed acoustic anomaly locator system that includes an optical frequency comb generator, according to some aspect of the inventive concepts.

FIG. 2 is a schematic diagram illustrating an embodiment of a distributed acoustic anomaly locator system, according to some aspect of the inventive concepts.

FIG. 3 is a schematic diagram illustrating an embodiment of a distributed acoustic anomaly locator system, according to some aspects of the inventive concepts.

FIG. 4 is a schematic diagram illustrating an embodiment of a distributed acoustic anomaly locator system, according to some aspects of the inventive concepts.

FIG. 5 is a schematic diagram illustrating an embodiment of a distributed acoustic anomaly locator system, according to some aspects of the inventive concepts.

FIG. 6 is a schematic diagram illustrating an embodiment of a distributed acoustic anomaly locator system, according to some aspects of the inventive concepts.

FIG. 7 is a schematic diagram illustrating an embodiment of a distributed acoustic anomaly locator system, according to some aspects of the inventive concepts.

FIG. 8A is a graphical representation illustrating an example of the demodulated optical frequency comb produced using sine wave frequency modulation (FM).

FIG. 8B is a graphical representation illustrating an example of the demodulated dense optical frequency comb resulting from square wave FM with an odd harmonic effect.

Similar reference numerals may have been used in different figures to denote similar components.

### DETAILED DESCRIPTION

### Introduction

Monitoring the integrity of civil structures, such as pipelines, bridges, or other infrastructures, can be achieved using distributed fiber-optic acoustic sensors. These sensors can detect various events of interest, such as leaks, construction-related strikes, or other acoustic or vibrational disturbances that may indicate structural issues. Traditional monitoring techniques often face limitations in signal strength or localization accuracy, for example due to weak backscattered signals. Enhancing the optical pulse width can increase the light launched into the fiber but at the cost of reduced event localization accuracy.

The inventive concepts described herein can improve the process of monitoring civil structures by employing an optical frequency comb generator that improves the detection and localization of acoustic anomalies. The disclosed techniques can use multiple frequency sidebands to improve the signal-to-noise ratio and/or reduce susceptibility to interference fading. For example, the interaction of different optical frequencies with Rayleigh backscatter at specific scattering centers can provide stronger and more distinguishable signals. By generating a pulse from an Optical Frequency Comb (OFC) generator, the system can improve the chances of detecting and locating signals of interest, thereby enhancing the overall monitoring capabilities.

Some inventive concepts described herein can improve the detection and localization of acoustic anomalies. In some cases, by utilizing continuous wave (CW) frequency modulated (FM) lasers and acousto-optical modulators (AOMs), the optical frequency comb generator can produce multiple frequency sidebands that interact variably with Rayleigh backscatter within an optical fiber. This can lead to improved signal strengths at distinct frequencies, enhancing the system's sensitivity and accuracy in detecting and locating acoustic anomalies.

Some inventive concepts described herein relate to enhancing the efficiency of monitoring systems by simplifying the generation of optical frequency combs, thereby reducing complexity and cost. In some cases, this can be achieved by using a CW FM laser and an AOM to generate the comb frequencies, which can then be processed by a receiver and data acquisition system. By demodulating the returned signal into a baseband frequency and converting it to an electrical signal, the system can process and analyze the data, facilitating accurate detection and localization of acoustic anomalies.

Some inventive concepts described herein can provide an improvement in the field of structural health monitoring by enabling more reliable and accurate detection of acoustic anomalies. By incorporating an optical frequency comb generator into distributed acoustic anomaly detection systems, these inventive concepts refine the approach to monitoring civil structures, conserving energy and bandwidth resources while providing reliable tracking and monitoring. The disclosed techniques allow for more effective and efficient structural health monitoring, improving the practical application of these technologies in various operational settings.

Some inventive concepts described herein relate to producing a dense optical frequency comb. In some cases, a dense optical frequency comb can be generated by employing harmonic-rich, non-sinusoidal modulation of the laser signal, using a CW FM laser source. The laser signal can undergo modulations such as square, sawtooth, or triangle wave modulation, characterized by a fundamental frequency and a series of harmonic frequencies. For example, depending on the modulating waveform, the resulting comb can include odd harmonics, or both odd and even harmonics, as seen with sawtooth wave modulation. An AOM can modulate the laser signal, resulting in an optical pulse that includes sidebands for the fundamental frequency and at least one of the odd harmonic frequencies, such as the 1st, 3rd, or 5th harmonic. The sidebands can be spaced apart with a guard band between adjacent sidebands. A dense optical frequency comb can provide closely spaced frequency sidebands, leading to improved resolution and accuracy in detecting acoustic anomalies. This improvement can improve monitoring by providing more detailed and precise detection and localization of anomalies, making the system more reliable and effective.

### EXAMPLE EMBODIMENTS

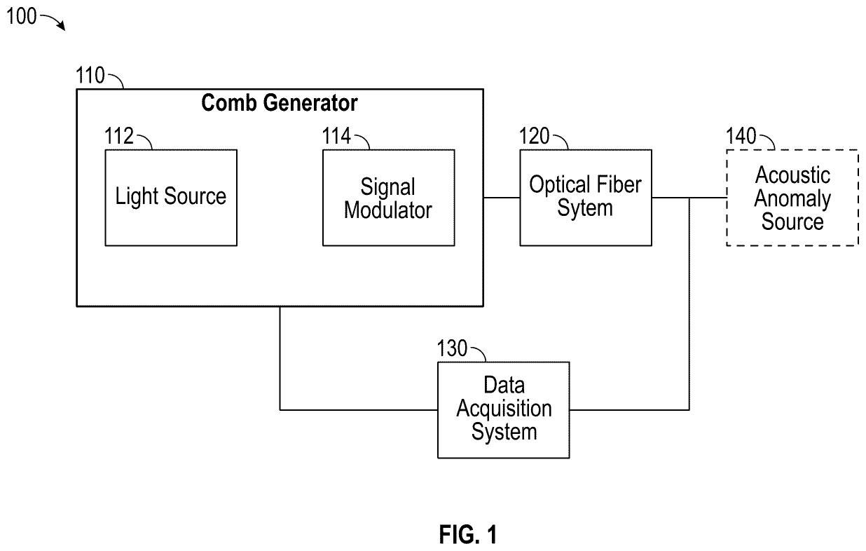

FIG. 1 is a schematic diagram illustrating an embodiment of a distributed acoustic anomaly locator system 100 that includes an optical frequency comb generator 110, according to some aspect of the inventive concepts. The distributed acoustic anomaly locator system 100 includes a comb generator 110, an optical fiber system 120, a data acquisition system 130, and an acoustic anomaly source 140.

The comb generator 110 can include a light source 112 and a signal modulator 114. The light source 112 can generate a light signal to be sent to the signal modulator 114 to produce an optical frequency comb. The implementation of the light source 112 can vary across embodiments. In some cases, the light signal can be a coherent light signal. For example, in some cases, the light source 112 can be a continuous wave (CW) laser configured to generate a continuous, coherent light beam. As another example, the light source 112 can be a pulsed laser configured to emit light in short bursts. In some cases, the light source 112 can be a tunable laser configured to adjust its wavelength based on specific requirements. The light source 112 can be selected based on specific requirements such as signal strength, coherence properties, and/or the intended application.

The signal modulator 114 can modulate the light signal generated by the light source 112 to produce an optical frequency comb. The implementation of the signal modulator 114 can vary across embodiments. In some cases, the signal modulator 114 can use modulation techniques such as frequency modulation (FM). These modulation techniques can result in multiple frequency sidebands, which can improve the signal-to-noise ratio of the system 100 and reduce susceptibility to interference fading.

The signal modulator 114 can introduce phase shifts in the light signal for specific modulation patterns. The choice of modulation pattern can influence the characteristics of the optical frequency comb. For instance, in some cases, the modulation pattern can be a square wave, which can increase the density of the optical frequency comb compared to sine wave modulation. Square wave modulation can generate sidebands that are spaced more closely together, providing a denser comb structure compared to the typically wider spacing seen with sine wave modulation. In some cases, the modulation pattern can be a sawtooth or triangle wave, each creating specific harmonic characteristics in the output signal. For example, sawtooth wave modulation can produce a linear frequency progression, resulting in a harmonic profile where the sidebands increase linearly in frequency. Triangle wave modulation can generate sidebands with a symmetric harmonic distribution, where the sidebands are evenly spaced around the fundamental frequency.

The signal modulator 114 can modulate the light signal generated by the light source 112 to produce an optical frequency comb. For example, the signal modulator 114 can use techniques such as frequency modulation (FM), amplitude modulation (AM), or phase modulation (PM) to alter the frequency, amplitude, and/or phase of the light signal. This modulation can produce multiple optical frequency components, collectively referred to as the optical frequency comb. The optical frequency comb can include the multiple frequency components produced by the combination of the carrier frequency of the light signal and an RF frequency applied by the signal modulator 114. In some cases, the production of the optical frequency comb can improve the signal-to-noise ratio of the system 100 and reduce susceptibility to interference fading. For example, the sidebands can interact variably with Rayleigh backscatter within an optical fiber, providing differentiated signal strengths at distinct frequencies and improving the sensitivity of detecting and locating acoustic anomalies.

The characteristics of an optical frequency comb can vary based on the type of modulation used. There can be at least two types of modulation patterns: sinusoidal and harmonic-rich, non-sinusoidal. Sinusoidal modulation, such as sine wave modulation, can provide symmetrically spaced sidebands centered around the fundamental frequency and its harmonics. This type of modulation can be cleaner and more regular, making it suitable for applications requiring precise frequency control and predictable harmonic spacing.

Harmonic-rich, non-sinusoidal modulation can produce a more complex and varied sideband structure. This type of modulation can include patterns such as square, sawtooth, or triangle waveforms, each creating distinct harmonic characteristics in the output signal. Harmonic-rich, non-sinusoidal modulation can offer a denser and more varied frequency comb, which can be advantageous for some applications, such as those requiring a broader frequency coverage and improved interaction with various optical phenomena, such as Rayleigh backscatter.

As an example, square wave modulation can generate sidebands that are spaced more closely together compared to sine wave modulation. This increased density of sidebands can enhance the system's ability to interact with a wider range of frequencies, beneficial for applications needing extensive frequency coverage. Square wave modulation can provide a denser comb structure, improving the system's performance in specific scenarios.

As another example, sawtooth wave modulation can produce a linear frequency progression, resulting in a harmonic profile where the sidebands increase linearly in frequency. This linear increase can offer a different harmonic characteristic, potentially providing advantages in applications benefiting from a linear frequency response. Sawtooth wave modulation can create sidebands with a progressive frequency structure, suitable for linear frequency modulation requirements.

As another example, triangle wave modulation can generate sidebands with a symmetric harmonic distribution, where the sidebands are evenly spaced around the fundamental frequency. This symmetric distribution can provide a balanced frequency comb, advantageous for applications requiring uniform sideband spacing and consistent frequency intervals. Triangle wave modulation can produce sidebands with a symmetric and predictable harmonic distribution.

In cases where the signal modulator 114 applies harmonic-rich, non-sinusoidal modulation, the light signal can be characterized by a fundamental frequency and a series of odd or odd and even harmonic frequencies. The outputted optical pulse can then include sidebands for the fundamental frequency and at least one of the odd harmonic frequencies, such as the 1st, 3rd, and/or 5th harmonic frequencies. In some such cases, the sidebands can be spaced apart with a guard band between adjacent sidebands.—In some cases, for example to ensure statistical independence of the harmonic lobes, the harmonic lobes can be separated by a sufficiently wide guard band. This width can be greater than the inverse of the pulse width generated by the optical comb generator output.

It will be appreciated that other modulation techniques can also be used in the signal modulator 114 to produce the optical frequency comb. For example, in some cases, the modulation pattern can be a chirped modulation, where the frequency of the signal increases or decreases over time, resulting in a swept-frequency comb. In some cases, amplitude modulation (AM) can be used to vary the intensity of the light signal, creating additional modulation sidebands. In some cases, phase shift keying (PSK) can be applied to modulate the phase of the light signal in discrete steps, generating a comb with specific phase characteristics. These variations in the implementation of the signal modulator 114 can provide flexibility in the system's performance for different applications.

The optical fiber system 120 can transmit the modulated light signal from the comb generator 110 to a structure under observation and return a signal indicative of any acoustic anomalies. The implementation of the optical fiber system 120 can vary across embodiments. For example, in some cases, the optical fiber can be a single-mode fiber, which can provide high precision and low loss over long distances. As another example, the optical fiber can be a multi-mode fiber, which can be used for shorter distances and can be more cost-effective. In some cases, the optical fiber can include a polarization-maintaining fiber to reduce polarization-induced fading and improve signal stability. In some cases, the optical fiber can be configured with specialized coatings or sheathing to enhance durability and environmental resistance. The optical fiber system 120 can be selected based on specific requirements such as signal integrity, distance, and environmental conditions.

The data acquisition system 130 can receive the returned signal from the optical fiber system 120 and process it to identify and locate acoustic anomalies within the monitored structure. In some cases, the data acquisition system 130 can include a coherent receiver configured to demodulate the optical signal into a baseband frequency for further analysis. The coherent receiver can convert the optical signal into an electrical signal, which can then be processed by software. In some implementations, the data acquisition system 130 can include a fast Fourier transform (FFT) processor to analyze the complex waveform and identify specific patterns indicative of structural issues. As another example, the data acquisition system 130 can include a wavelet transform processor for detailed time-frequency analysis. In some cases, the data acquisition system 130 can include parallel or sequential band-pass filters to isolate the signal of interest and determine the location and characteristics of the acoustic anomalies.

The acoustic anomaly source 140 represents potential sources of acoustic anomalies within the monitored structure. In some cases, the acoustic anomaly source 140 can be a pipeline, where anomalies such as leaks, strain variations caused by pressure changes, intrusion, or tensioned reinforcing failures can be detected. As another example, the acoustic anomaly source 140 can be a bridge, where structural issues such as tensioned reinforcing failures can be monitored. In some cases, the acoustic anomaly source 140 can be part of a building's infrastructure, detecting events like potential strikes during construction. In some cases, the acoustic anomaly source 140 can be any civil structure where acoustic monitoring is critical for maintenance and safety.

### Example Comb Generator

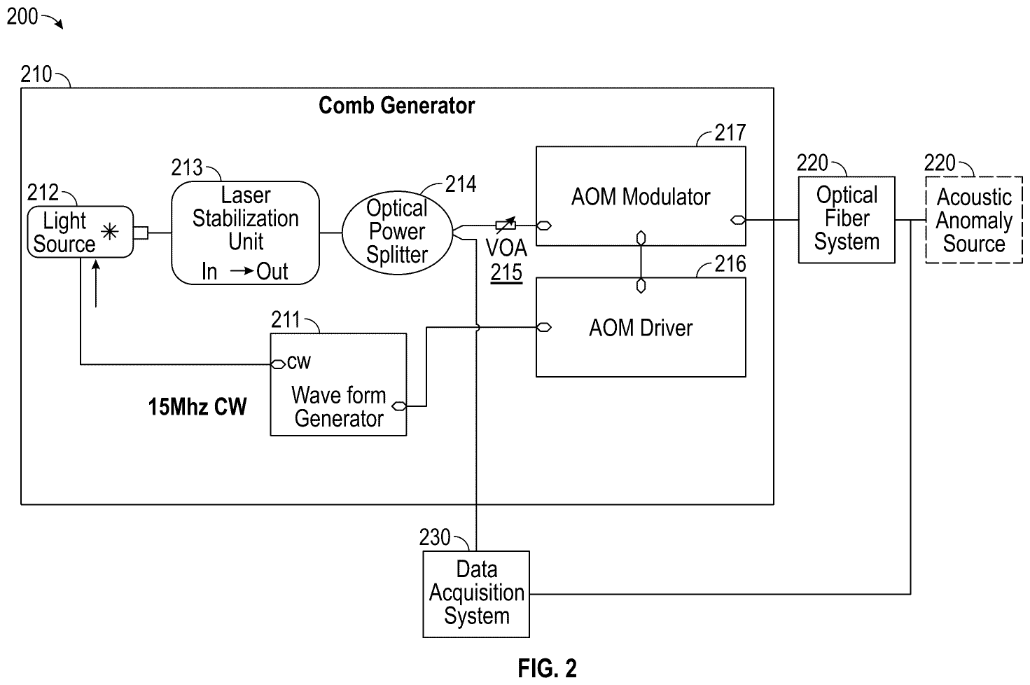

FIG. 2 is a schematic diagram illustrating an embodiment of a distributed acoustic anomaly locator system 200, according to some aspect of the inventive concepts. Here, the system 200 includes a comb generator 210, an optical fiber system 220, a data acquisition system 230, and an acoustic anomaly source 240, which may be embodiments of the comb generator 110, the optical fiber system 120, the data acquisition system 130, and the acoustic anomaly source 140, respectively, of FIG. 1.

As described herein, the comb generator 210 can produce an optical frequency comb by modulating a light signal. The comb generator 210 include a waveform generator 211, a light source 212, an isolator 213, an optical power splitter 214, a Variable Optical Attenuator (VOA) 215, an acousto-optical modulator (AOM) driver 216, and/or an MODULATOR 217. It will be appreciated that the comb generator 210 can include fewer, more, or different components, depending on the embodiment.

The waveform generator 211 can generate one or more of various modulation patterns to modulate the light signal. These modulation patterns can depend on the specific application and the desired characteristics of the optical frequency comb. For example, in some cases, the modulation can be harmonic-rich, non-sinusoidal modulation, which can include patterns such as, but not limited to, square (rectangular), sawtooth, or triangle waveforms. In some cases, the modulation can be sinusoidal, such as sine wave modulation. The choice of modulation pattern can influence the characteristics of the optical frequency comb, including the spacing and distribution of sidebands. The modulated signal can then be sent to the light source 212. In some cases, in addition to or in place of the waveform generator 211, other techniques such as direct digital synthesis (DDS) or external modulation using electro-optic modulators can be employed to achieve the desired modulation effect.

The light source 212 can be an embodiment of the light source 112 of FIG. 1. The light source 212 can generate a light signal based on the modulation pattern received from the waveform generator 211. In some cases, the light source 212 can be a continuous wave (CW) laser, providing a stable light source for modulation.

The isolator 213 can be configured to stabilize an output of the light source 212, ensuring consistent performance. This stabilization can be achieved through various methods, such as external cavity configurations or feedback control mechanisms. In some cases, the isolator 213 can include an external cavity narrow linewidth laser (NLL), for example to provide stability and reduce spectral linewidth. The stabilized light signal can be passed to the optical power splitter 214. The isolator 213 can be configured to prevent or reduce back reflections.

The optical power splitter 214 can divide the optical signal from the isolator 213, directing a portion of the signal to the primary path and another portion to an auxiliary path for monitoring or additional processing. The power splitter 214 can be configured with various splitting ratios, such as 90:10 or 99:1, to allocate the optical power according to the needs of the system. In some cases, the power splitter 214 can be configured with other ratios, such as, but not limited to, 80:20, 70:30, or 50:50. The optical power splitter 214 can include different types of splitters, such as, but not limited to, fused biconical taper (FBT) splitters, planar lightwave circuit (PLC) splitters, or directional couplers.

The variable optical attenuator (VOA) 215 can be used to adjust the power level of the optical signal from the primary path of the optical power splitter 214, preparing it for further transmission. The VOA 215 can provide precise control over the signal power, which can facilitate the proper functioning of the subsequent components in the comb generator 210.

The AOM modulator driver 216 can control an AOM modulator 217, which can modulate the optical signal from the light source 212 based on the modulation pattern generated by the waveform generator 211. The AOM modulator 217 can alter the amplitude and frequency of the light signal, producing an optical pulse with multiple frequency sidebands and forming an optical frequency comb. The modulation can include various techniques, such as frequency modulation (FM). In some cases, the AOM modulator 217 can operate at specific frequencies with pulsed ON control, enabling precise control over the modulation process. In some cases, the AOM modulator driver 216 can include an acousto-optic modulator (AOM) driver, and the AOM modulator 217 can include an AOM. Other types of modulators and control techniques can also be used, depending on the specific requirements of the system.

In some cases, the AOM modulator 217 is configured to shift the frequency of the light signal based on an applied radio frequency (RF) drive signal from the AOM modulator driver 216. The AOM modulator 217 receives the light signal from the light source 112 and the RF drive signal, which modulates the light signal by altering its amplitude and frequency. The output of the AOM modulator 217 can shift the modulated light center frequency up or down by the RF drive applied to the AOM modulator 217. As described herein, an “optical frequency comb” can refer to the multiple, frequency components produced by the combination of the light signal's FM modulation carrier frequency and the AOM RF frequency (the frequency of the applied RF drive signal).

Consider a scenario where an FM modulation carrier frequency of the light signal is 15 MHz, and the AOM RF frequency is 80 MHz. This configuration can produce 80 MHz as the center lobe, with positive and negative sideband lobes in multiples of 15 MHz. For instance, to limit the spread to five lobes in this example, the frequencies can be 50 MHZ, 65 MHZ, (80 MHZ center lobe), 95 MHz, and 110 MHz. This pattern can be an example of an optical frequency comb. The AOM modulator 217 can modulate the light signal by altering its amplitude and frequency based on the RF drive signal, outputting an optical pulse with multiple frequency sidebands. The sidebands can be symmetrically spaced or characterized by harmonic-rich, non-sinusoidal modulation.

In some cases, the signal modulator 114 can be operated in different modes to achieve the desired modulation effect. For instance, the AOM modulator 217 can be operated in either a pulsed mode or a continuous mode. In pulsed mode, the AOM modulator 217 generates short bursts of modulated light. This mode can be advantageous for applications requiring precise timing and high peak power, such as time-domain reflectometry, where accurate distance measurements are needed. Pulsed mode can provide high-resolution data by emitting discrete, high-intensity light bursts, allowing for detailed and accurate detection of anomalies over short time intervals. The resulting optical frequency comb in pulsed mode can have a higher peak power and sharper definition of frequency components, which can enhance the detection of specific events within a narrow timeframe.

In continuous mode, the AOM modulator 217 continuously modulates the light signal without interruption. This mode can be beneficial for applications requiring a stable and consistent signal, such as continuous monitoring systems. Continuous mode can offer a steady stream of data, which is useful for real-time monitoring and long-term stability in signal analysis. This mode allows for uninterrupted data collection, which can be beneficial in applications that require ongoing observation and immediate anomaly detection. The resulting optical frequency comb in continuous mode can provide a more stable and consistent set of frequency components, which can be advantageous for applications that rely on long-term signal analysis and require a continuous spectrum of data. In some cases, loss of location may be a consequence. In some such cases, the system can include an additional optical switch or gate such as a semiconductor optical amplifier (SOA).

It will be appreciated that the comb generator 210 may include fewer, additional, or different components. For example, in some cases, the comb generator 210 may include additional signal amplifiers to boost the modulated light signal before transmission. In other cases, the comb generator 210 may include fewer components, such as omitting the isolator 213 if laser stabilization is not required. Additionally, different types of modulators or signal processing units could be integrated to enhance the generation and control of the optical frequency comb.

### Optical Fiber System

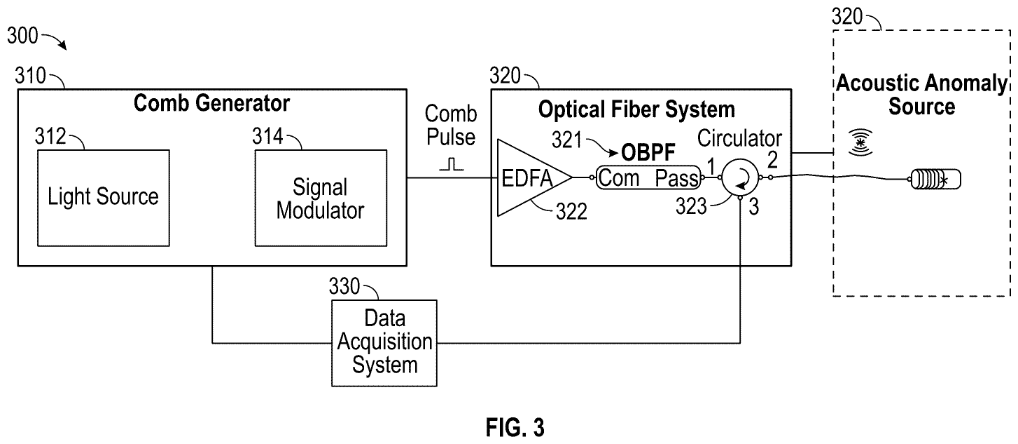

FIG. 3 is a schematic diagram illustrating an embodiment of a distributed acoustic anomaly locator system 300, according to some aspects of the inventive concepts. Here, the system 300 includes a comb generator 310, an optical fiber system 320, a data acquisition system 330, and an acoustic anomaly source 340, which may be embodiments of the comb generator 110, the optical fiber system 120, the data acquisition system 130, and the acoustic anomaly source 140, respectively, of FIG. 1.

The optical fiber system 320 can transmit the modulated light signal from the comb generator 310 to the structure under observation and return a signal indicative of any acoustic anomalies. The optical fiber system 320 can include various components such as an optical bandpass filter (OBPF) 321, an erbium-doped fiber amplifier (EDFA) 322, and a circulator 323. The OBPF 321 can filter the incoming comb pulse to select specific wavelengths for further transmission. The EDFA 322 can amplify the filtered optical signal to compensate for any losses incurred during transmission. The circulator 323 can direct the amplified signal towards the structure under observation and route the returned signal to the data acquisition system 330.

The acoustic anomaly source 340 represents potential sources of acoustic anomalies within the monitored structure. These anomalies can include events such as leaks, potential strikes during construction, or tensioned reinforcing failures. The acoustic anomaly source 340 can be any part of a civil structure such as pipelines, bridges, or other infrastructure components where acoustic monitoring is critical for maintenance and safety. The acoustic anomaly source 340 can generate acoustic signals in response to such events, which are then transmitted back through the optical fiber system 320 to the data acquisition system 330 for analysis.

### Example Data Acquisition System

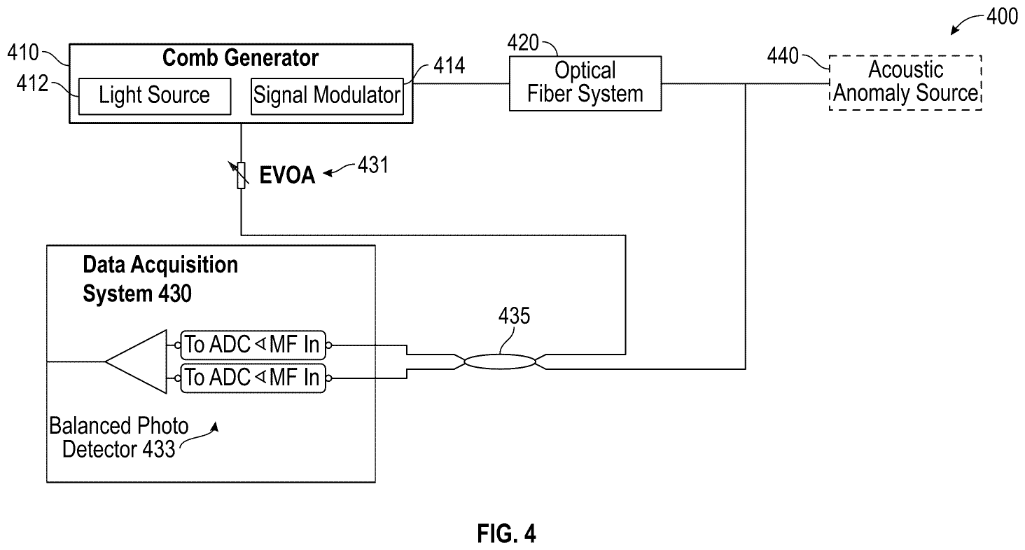

FIG. 4 is a schematic diagram illustrating an embodiment of a distributed acoustic anomaly locator system 400, according to some aspects of the inventive concepts. Here, the system 400 includes a comb generator 410, an optical fiber system 420, a data acquisition system 430, and an acoustic anomaly source 440, which may be embodiments of the comb generator 110, the optical fiber system 120, the data acquisition system 130, and the acoustic anomaly source 140, respectively, of FIG. 1.

The data acquisition system 430 can receive a returned signal from the optical fiber system 420 and a modulated reference signal from the comb generator 410. The data acquisition system 430 can process these signals to compare the reference signal with the returned signal, identifying and locating acoustic anomalies within the monitored structure.

The data acquisition system 430 can include various components such as a variable optical attenuator (VOA) (e.g., an Electrical Variable Optical Attenuator or EVOA for remote control) 431, polarization-maintaining components 432, and a balanced photodetector 433. The VOA 431 can be used to adjust the power level of the incoming modulated signal to prepare it for detection. This adjustment can facilitate accurate detection and analysis.

The polarization-maintaining components 432 can be used to maintain the polarization state of the optical signal. These components can include polarization-maintaining (PM) fibers and related devices. Maintaining the polarization state can reduce signal degradation and help ensure that the signal is correctly interpreted by the subsequent components for accurate signal detection.

The 2×2 coupler 435 can split the optical signal into two separate paths. This splitting can be used to direct a portion of the signal to the balanced photodetector 433 and another portion to different components for monitoring or additional processing, if using an unbalanced or balanced receiver with a 3×3 coupler.

The photodetector 433 can convert the optical signal into an electrical signal. The photodetector 433 can help reduce noise and improve the signal-to-noise ratio by detecting the difference between two complementary optical signals: the modulated reference signal from the comb generator 410 and the returned signal from the optical fiber system 420. In some cases, the photodetector 433 is a balanced photodetector. The photodetector 433 may include two analog-to-digital converters (ADCs) to convert the detected signal from an analog electrical signal into digital signals, and a single operational amplifier (op amp) to amplify the signal for further processing.

Example Data Acquisition System with Optical Hybrid

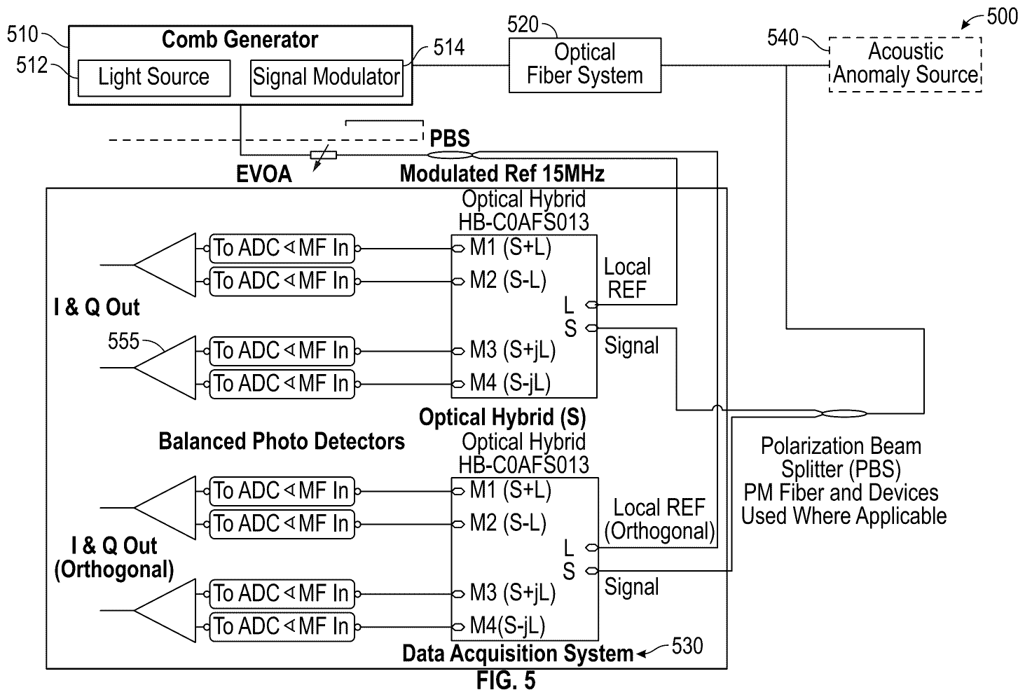

FIG. 5 is a schematic diagram illustrating an embodiment of a distributed acoustic anomaly locator system 500, according to some aspects of the inventive concepts. Here, the system 500 includes a comb generator 510, an optical fiber system 520, a data acquisition system 530, and an acoustic anomaly source 540, which may be embodiments of the comb generator 110, the optical fiber system 120, the data acquisition system 130, and the acoustic anomaly source 140, respectively, of FIG. 1.

The data acquisition system 530 can receive a returned signal from the optical fiber system 520 and a modulated reference signal from the comb generator 510. The data acquisition system 530 can process these signals to compare the reference signal with the returned signal, identifying and locating acoustic anomalies within the monitored structure.

Example Data Acquisition System with Polarization Diversity Receiver

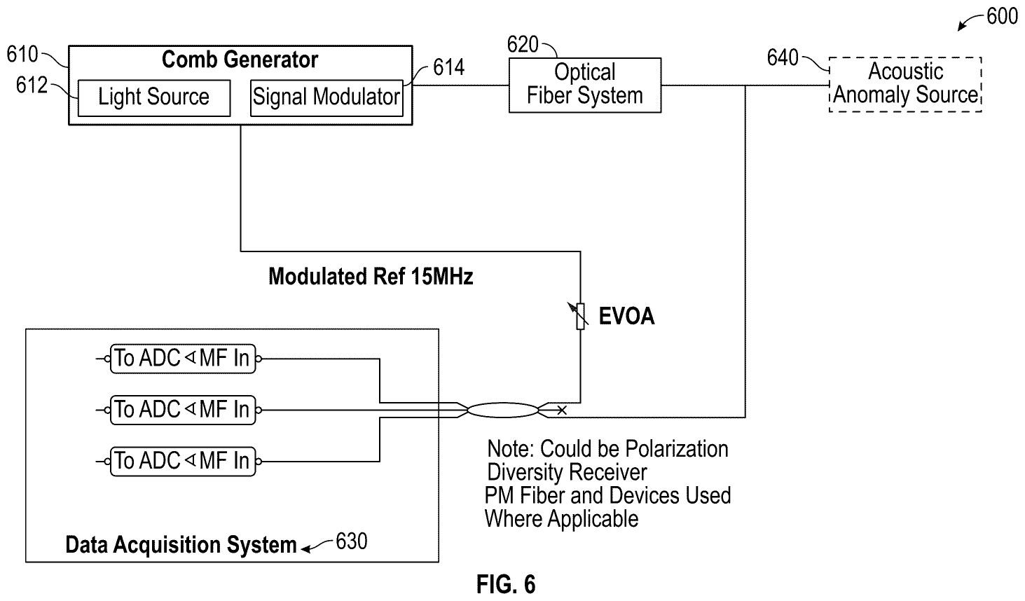

FIG. 6 is a schematic diagram illustrating an embodiment of a distributed acoustic anomaly locator system 600, according to some aspects of the inventive concepts. Here, the system 600 includes a comb generator 610, an optical fiber system 620, a data acquisition system 630, and an acoustic anomaly source 640, which may be embodiments of the comb generator 110, the optical fiber system 120, the data acquisition system 130, and the acoustic anomaly source 140, respectively, of FIG. 1.

The data acquisition system 630 can receive a returned signal from the optical fiber system 620 and a modulated reference signal from the comb generator 610. The data acquisition system 630 can process these signals to compare the reference signal with the returned signal, identifying and locating acoustic anomalies within the monitored structure.

Example Data Acquisition System with Polarization Diversity Receiver and Beam Splitter

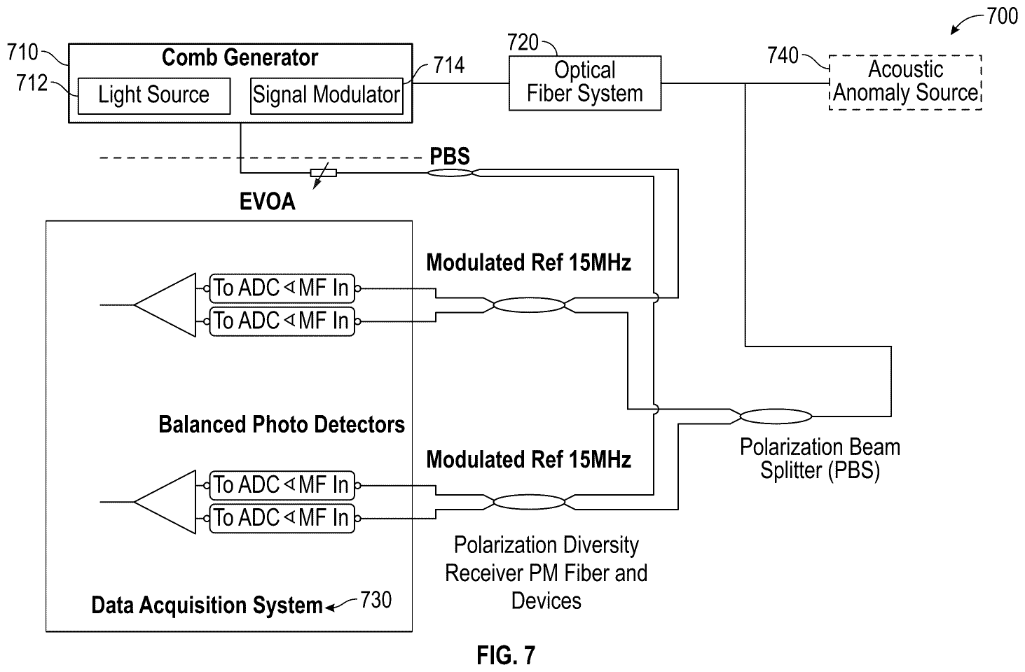

FIG. 7 is a schematic diagram illustrating an embodiment of a distributed acoustic anomaly locator system 700, according to some aspects of the inventive concepts. Here, the system 700 includes a comb generator 710, an optical fiber system 720, a data acquisition system 730, and an acoustic anomaly source 740, which may be embodiments of the comb generator 110, the optical fiber system 120, the data acquisition system 130, and the acoustic anomaly source 140, respectively, of FIG. 1.

The data acquisition system 730 can receive a returned signal from the optical fiber system 720 and a modulated reference signal from the comb generator 710. The data acquisition system 730 can process these signals to compare the reference signal with the returned signal, identifying and locating acoustic anomalies within the monitored structure.

### Example Demodulated Optical Frequency Comb

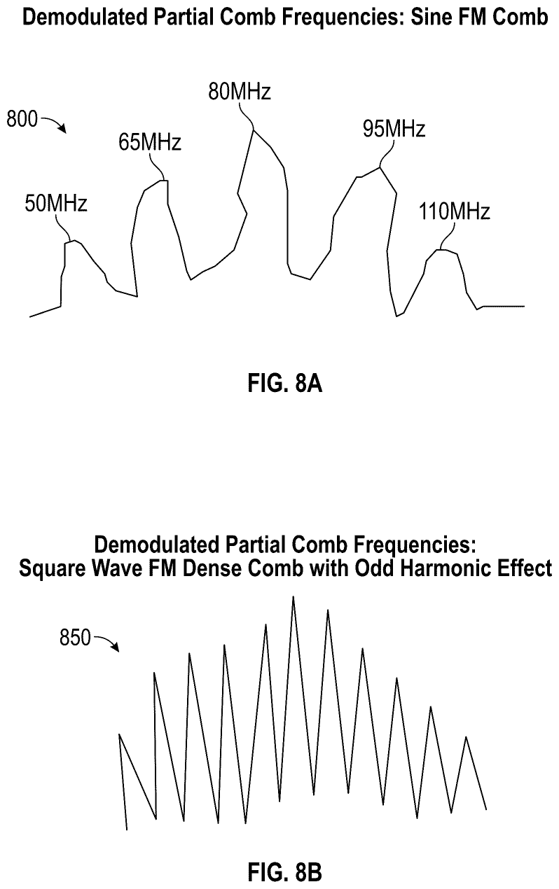

FIG. 8A is a graphical representation 800 illustrating an example of the demodulated optical frequency comb produced using sine wave frequency modulation (FM). In this example, the optical frequency comb includes multiple frequency sidebands centered around a fundamental frequency. The FM modulation carrier frequency of the light signal is 15 MHZ, and the AOM RF frequency is 80 MHz. This configuration results in 80 MHz as the center lobe, with positive and negative sideband lobes appearing in multiples of 15 MHz. The depicted frequencies are 50 MHZ, 65 MHz, 80 MHz (center lobe), 95 MHz, and 110 MHz. These five specific frequencies result from applying a band-pass filter during the during the emission or demodulation process, which limits the spread of the comb to these frequencies. The peaks in the graph represent the signal intensity at each of these frequency components, demonstrating the harmonic structure produced by sine wave modulation. The symmetrical spacing of the sidebands around the central frequency creates the comb-like pattern typical of sine wave FM modulation.

The use of sine wave modulation can offer several benefits. For example, the symmetrical sidebands provide a cleaner and more predictable frequency structure, which can be advantageous for applications requiring precise frequency control. The multiple frequency sidebands can improve the signal-to-noise ratio of the system, enhancing the clarity of the detected signal. Additionally, the evenly spaced sidebands can reduce the effects of interference fading, improving the reliability of signal detection. In comparison to not using an optical frequency comb, a single-frequency system would be more susceptible to noise and signal degradation, and would provide less information about the monitored structure, reducing the accuracy of anomaly detection.

FIG. 8B is a graphical representation 850 illustrating an example of the demodulated dense optical frequency comb resulting from square wave frequency modulation (FM) with an odd harmonic effect. The comb structure in this figure is characterized by closely spaced frequency components, indicating a denser distribution of sidebands compared to the sine wave modulation shown in FIG. 8A. In this case, square wave modulation produces additional harmonic frequencies, leading to a more complex and varied frequency comb. The peaks in the graph represent signal intensity at specific frequency intervals, showing a series of closely spaced sidebands. This denser comb structure results from the square wave modulation creating multiple odd harmonics, enhancing the system's ability to cover a broader frequency range. The filtering during the emission or demodulation process may also play a role in isolating these specific frequency components, contributing to the observed pattern in the frequency comb.

The use of square wave modulation can provide several benefits. For example, the closely spaced sidebands result in a denser frequency comb, which can be useful for applications requiring broad frequency coverage. The dense sideband structure improves the interaction with various optical phenomena, such as Rayleigh backscatter, thereby enhancing the system's sensitivity. Furthermore, the additional harmonic frequencies can provide more detailed information about the monitored structure, improving the resolution of anomaly detection. In comparison to not using an optical frequency comb, a single-frequency system would have less frequency coverage, reducing the ability to detect a wide range of anomalies. A single-frequency system may also be less sensitive to variations in the monitored structure, decreasing the overall effectiveness of the detection process.

By employing different modulation techniques to produce an optical frequency comb, the system can offer significant advantages over traditional single-frequency methods, thereby enhancing both the sensitivity and accuracy of acoustic anomaly detection.

### Terminology

Although this disclosure has been described in the context of certain embodiments and examples, it will be understood by those skilled in the art that the disclosure extends beyond the specifically disclosed embodiments to other alternative embodiments and/or uses and obvious modifications and equivalents thereof. In addition, while several variations of the embodiments of the disclosure have been shown and described in detail, other modifications, which are within the scope of this disclosure, will be readily apparent to those of skill in the art. It is also contemplated that various combinations or sub-combinations of the specific features and aspects of the embodiments may be made and still fall within the scope of the disclosure. For example, features described above in connection with one embodiment can be used with a different embodiment described herein and the combination still fall within the scope of the disclosure. It should be understood that various features and aspects of the disclosed embodiments can be combined with, or substituted for, one another in order to form varying modes of the embodiments of the disclosure. Thus, it is intended that the scope of the disclosure herein should not be limited by the particular embodiments described above. Accordingly, unless otherwise stated, or unless clearly incompatible, each embodiment of this invention may include, additional to its essential features described herein, one or more features as described herein from each other embodiment of the invention disclosed herein.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately,” “about,” “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, 0.1 degree, or otherwise.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

What is claimed is:

1. An optical frequency comb generator for a distributed acoustic anomaly detection system, comprising:
a continuous wave (CW) frequency modulation (FM) laser source configured to generate a laser signal; and
an acousto-optic modulator (AOM) configured to modulate the laser signal by altering an amplitude and frequency of the laser signal based on an RF drive signal applied to the AOM, and to output an optical pulse with multiple frequency sidebands based on the modulation,
wherein the output forms an optical frequency comb usable detecting and locating acoustic anomalies within a structure under observation.

2. The optical frequency comb generator of claim 1, wherein the laser signal undergoes sine wave modulation, and wherein the optical frequency comb comprises symmetrically spaced sidebands.

3. The optical frequency comb generator of claim 1, wherein the laser signal undergoes sine wave modulation, such that the laser signal is characterized by a fundamental frequency, and wherein the AOM modulates the laser signal such that the outputted optical pulse comprises sidebands for the fundamental frequency.

4. The optical frequency comb generator of claim 1, wherein the laser signal undergoes harmonic-rich, non-sinusoidal modulation such that the laser signal is characterized by a fundamental frequency and a series of odd harmonic frequencies, and wherein the AOM modulates the laser signal such that the outputted optical pulse comprises sidebands for the fundamental frequency and at least one of the odd harmonic frequencies.

5. The optical frequency comb generator of claim 4, wherein the outputted optical pulse comprises at least the 1st, 3rd, and 5th harmonic frequencies.

6. The optical frequency comb generator of claim 4, wherein the sidebands are spaced apart with a guard band between adjacent sidebands, the guard band being at least two and a half times a frequency difference between the fundamental frequency and a nearest harmonic frequency.

7. The optical frequency comb generator of claim 6, wherein the harmonic-rich, non-sinusoidal modulation is at least one of square, sawtooth, or triangle wave modulation.

8. The optical frequency comb generator of claim 1, wherein the multiple frequency sidebands interact variably with Rayleigh backscatter within an optical fiber, thereby providing differentiated signal strengths at distinct frequencies to improve the sensitivity of the detecting and locating.

9. The optical frequency comb generator of claim 1, wherein the laser source is configured to operate with a square wave modulation, and wherein the square wave modulation increases a density of the optical frequency comb as compared to a laser source operating with a sine wave modulation.

10. The optical frequency comb generator of claim 1, further comprising an optical isolator positioned between the CW FM laser source and the AOM, wherein the optical isolator inhibits feedback into the laser source and stabilizes the laser signal.

11. The optical frequency comb generator of claim 1, wherein an optical fiber transmits the optical frequency comb and returns a signal indicative of acoustic anomalies within the structure.

12. The optical frequency comb generator of claim 11, wherein a data acquisition system demodulates the signal indicative of acoustic anomalies into a baseband frequency for subsequent analysis, wherein the data acquisition system converts the optical signal to an electrical signal, resulting in a complex waveform. The raw waveform is processed in software, where it is passed through parallel or sequential band-pass filters to generate the signal of interest.

13. The optical frequency comb generator of claim 12, wherein a data acquisition system receives the demodulated signal from the coherent receiver and determines a location of the acoustic anomalies within the structure based on said signal.

14. The optical frequency comb generator of claim 1, wherein the optical frequency comb generator is part of a monitoring system for at least one of pipelines, bridges, or civil structures.

15. The optical frequency comb generator of claim 1, wherein the optical frequency sidebands are generated based on an FM modulation carrier frequency from the CW FM laser and an RF frequency of the RF drive signal of the AOM, resulting in a series of sidebands at multiples of the carrier frequency.

16. The optical frequency comb generator of claim 1, further comprising a band-pass filter configured to limit a spread of the optical frequency comb pulse to a predetermined number of sidebands.

17. A distributed acoustic anomaly detection system comprising:
optical frequency comb generator configured to output an optical frequency comb pulse with multiple frequency sidebands, wherein the optical frequency comb generator comprises a source of a continuous wave frequency modulation (FM) light configured to provide a light signal, and an acousto-optic modulator (AOM) for modulating the light signal to generate the optical frequency comb pulse;
an optical fiber configured to transmit the optical frequency comb pulse and to return a signal indicative of acoustic anomalies within a structure under observation;
a coherent receiver configured to demodulate the returned signal into a baseband frequency; and
a data acquisition system configured to determine location information for the acoustic anomalies.

18. The distributed acoustic anomaly detection system of claim 17, wherein the light signal has sine wave modulation, and wherein the optical frequency comb comprises symmetrically spaced sidebands.

19. The distributed acoustic anomaly detection system of claim 17, wherein the light signal undergoes square wave modulation such that the light signal is characterized by a fundamental frequency and a series of odd harmonic frequencies, and wherein the AOM modulates the light signal such that the outputted optical pulse comprises sidebands for the fundamental frequency and at least one of the odd harmonic frequencies.

20. The distributed acoustic anomaly detection system of claim 17, wherein the light signal undergoes sine wave modulation, such that the light signal is characterized by a fundamental frequency, and wherein the AOM modulates the light signal such that the outputted optical pulse comprises sidebands for the fundamental frequency.
